(19) United States
(12) Patent Application Publication
(10) Pub. No.: US 2007/0072044 A1
(43) Pub. Date: Mar. 29, 2007

(54) FLUID MANAGEMENT COMPONENT FOR USE IN FUEL CELL

(76) Inventor: Eiichi Sakaue, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/532,785

(22) Filed: Sep. 18, 2006

(30) Foreign Application Priority Data
Sep. 28, 2005 (JP) 2005-281650

(51) Int. Cl. H01M 2/08; H01M 8/02; C04B 35/64; B05D 5/12

(52) U.S. Cl. 429/35; 429/38; 264/618; 427/115

(57) ABSTRACT

A fluid management component for use in a fuel cell comprises an anode, a cathode, an electrolyte membrane provided between the anode and the cathode, a porous body having a fuel supplying surface portion which faces the surface of the anode opposite to the electrolyte membrane and has channel portions and protruding portions in contact with the anode, and a sealing film which covers at least parts of the channel portions and blocks the permeation of a fluid through the fuel supplying surface portion.

### CROSS-REFERENCE TO RELATED APPLICATIONS

This application is based upon and claims the benefit of priority from prior Japanese Patent Application No. 2005-281650, filed Sep. 28, 2005, the entire contents of which are incorporated herein by reference.

### BACKGROUND OF THE INVENTION

1. Field of the Invention

The present invention relates to a fluid management component for use in a direct methanol fuel cell (DMFC).

2. Description of the Related Art

A fuel cell is a system for producing a free energy conversion, which is created through a chemical reaction of a fuel with an oxidizer, in the form of electricity. The fuel is mainly hydrogen or hydrocarbon, and the oxidizer is oxygen in most cases. The fuel cell has two electrodes as electron conductors and an electrolyte as an ion conductor to produce a free energy conversion created by the chemical reaction of the fuel and the oxidizer in the form of electric energy.

The fuel cell is categorized into several types of fuel cells according to the types of the fuel and the electrolyte. Those types of fuel cells are, for example, a direct methanol fuel cell (DMFC), a molten carbonate fuel cell (MCFC), and a solid polymer fuel cell (PEFC).

A membrane electrode assembly (MEA) of the DMFC includes an anode, a cathode, and an electrolyte membrane. Methanol (CH₃OH) and water (H₂O) are supplied to the anode. Usually, both the methanol and water are mixed into a methanol aqueous solution, and the aqueous solution is supplied to the anode. Oxygen (CO₂) is supplied to the cathode.

A reaction of the following formula (1) occurs at the anode.
CH₃OH+H₂O→CO₂+6H⁺+6e⁻−121.9 kJ/mol (1)

A reaction of the following formula (2) occurs at the cathode.
2/3O₂+6H⁺+6e⁻→3H₂O+141.95 kJ/mol (2)

The electrolyte membrane has such a selectivity that the membrane prohibits electrons (e⁻) from passing therethrough, but allows protons (H⁺) to pass therethrough. With this selectivity, the electrons have no choice but to travel outside the cell, and those electrons as electric energy are led out of the cell.

Thus, the fuel cell is required to have a function to supply CH₃OH and H₂O to the anode side and to remove CO₂ and another function to supply O₂ to the cathode and to remove H₂O. Those functions will be described in more detail.

A method of supplying the fuel to the MEA of the DMFC comes in two varieties, an active type and a passive type. In the active type DMFC, the fuel is supplied to the MEA by using a fuel channel plate and active auxiliary devices(pump and the like). In the passive type DMFC, the fuel is supplied passively to the anode side of the MEA through a porous body, by the using capillary effect or diffusion effect without any active auxiliary devices.

Inside the anode, CO₂ generated through the reaction of formula (1) is naturally removed by pressure difference and/or natural diffusion to outside the fuel cell. O₂ necessary for the cathode reaction of formula (2) is contained in air, and is fed to the cathode side by natural diffusion. H₂O generated by the reaction of formula (2) likewise is removed to outside the fuel cell by natural diffusion and the like.

If the removing CO₂ stagnates, the fuel supply to the anode side is impeded, thereby resulting in reduction of the power generation efficiency. To cope with this, in USP No. 2004/0062980A1 (patent document 1), there is a proposal to form channels on a porous body in order to promote to remove CO₂ from a fuel cell.

In the conventional approach of the passive type, methanol and water evaporate from the outside wall surface of the porous body, resulting in decrease of the fuel utilization efficiency. Further, the porous body component having channels for CO₂ removal disclosed in the patent document 1 has a further problem. That is, the methanol and the water are easy to evaporate through the surface of the channels. Hence, additional water and methanol must be kept in the fuel tank in order to compensate for the lost water, which is caused by those problems.

### BRIEF SUMMARY OF THE INVENTION

According to one aspect of the present invention, there is provided a fluid management component for use in a fuel cell, comprising: an anode; a cathode; an electrolyte membrane provided between the anode and the cathode; a porous body having a fuel supplying surface portion which faces the surface of the anode opposite to the electrolyte membrane and has channel portions and protruding portions in contact with the anode; and a sealing film which covers at least parts of the channel portions and blocks the permeation of a fluid through the fuel supplying surface portion.

According to another aspect of the present invention, there is provided a method of manufacturing a fluid management component for use in a fuel cell, comprising: (a) forming a pattern of channel portions and protruding portions on one side of a sheet-like preform; (b) attaching a mask having patterned openings corresponding to the channel portions of the preform to the preform, and covering one side of the preform with the mask; (c) forming a sealing film on the channel portions of the preform through the mask, and then removing an unnecessary film as well as the mask, thereby forming a porous body having a fuel inlet port and a fuel supplying surface portion; (d) sintering an anode, a cathode and an electrolyte membrane by a hot pressing method into a unit body, thereby obtaining a membrane electrode assembly; and (e) mounting the porous body on the membrane electrode assembly so that the protruding portions of the fuel supplying surface portion are in contact with the anode, and mounting the porous body on a fuel tank so that the fuel inlet port communicates with the fuel tank.

According to still another aspect of the present invention, there is provided a method of manufacturing a fluid management component for use in a fuel cell, comprising: (i) forming a pattern of channel portions and protruding portions on one side of a sheet-like preform; (ii) forming a sealing film on the entire surface of the one side of the preform; (iii) selectively removing the sealing film from the protruding portions by using physical removing means or chemical removing means, thereby obtaining a porous body having a fuel inlet port and a fuel tank; (iv) sintering an anode, a cathode and an electrolyte membrane by a hot pressing method into a unit body, thereby obtaining a membrane electrode assembly; and (v) mounting the porous body on the membrane electrode assembly so that the protruding portions of the fuel supplying surface portion are in contact with the anode, and mounting the porous body on the fuel tank so that the fuel inlet port communicates with the fuel tank.

### BRIEF DESCRIPTION OF THE SEVERAL VIEWS OF THE DRAWING

FIG. 1 is a cross-sectional view schematically showing a fluid management component for use in a fuel cell, in accordance to the embodiment;

FIG. 2 is a perspective view showing a porous body of the fluid management component of FIG. 1;

FIG. 3 is an enlarged cross sectional view showing a part of the porous body of the fluid management component of FIG. 1;

FIG. 4 is a plan view schematically showing a porous body having a stripe pattern of protruding portions, which extends in a longitudinal direction (Y direction);

FIG. 5 is a plan view schematically showing a porous body having a stripe pattern of protruding portions, which extends in a direction orthogonal to the longitudinal direction (Z direction);

FIG. 6 is a cross-sectional view schematically showing layered porous bodies;

FIGS. 7A and 7B are views exemplarily showing a manufacturing process according to a method of manufacturing a porous body; and

FIGS. 8A and 8B are views showing a manufacturing process according to another method of manufacturing a porous body.

### DETAILED DESCRIPTION OF THE INVENTION

One embodiment of the present invention will be described with reference to the accompanying drawings.

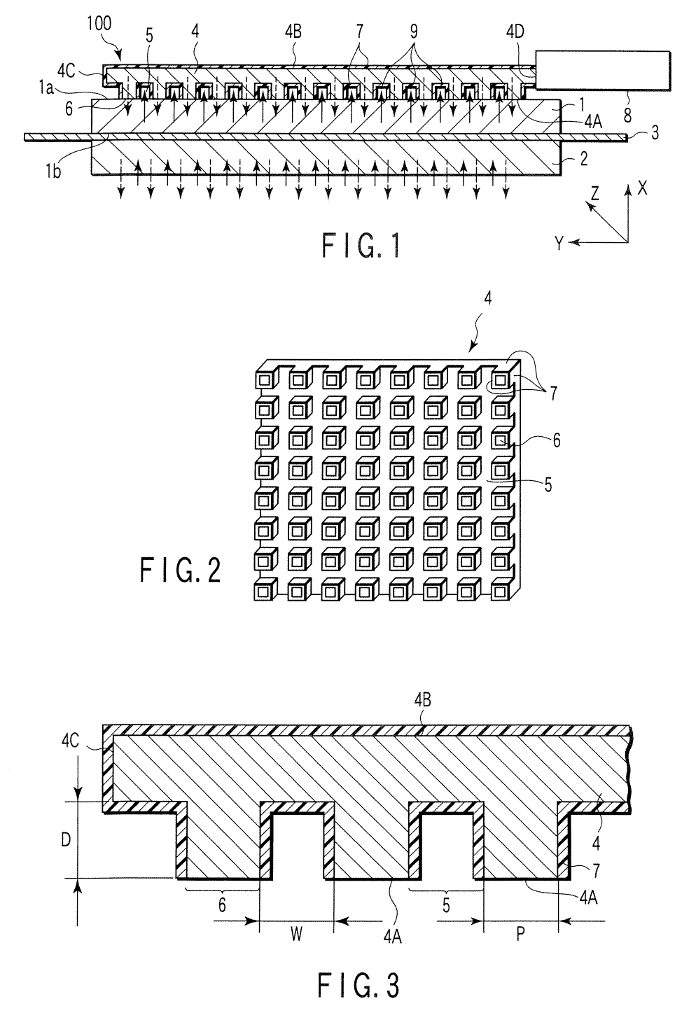

A fluid management component 100 for use in a fuel cell shown in FIG. 1 is provided with an anode 1, a cathode 2, an electrolyte membrane 3 and a porous body 4. The anode 1 includes a catalyst layer for supporting a catalyst, a gas diffusion layer and an electrode layer. The cathode 2 likewise includes a catalyst layer, a gas diffusion layer and an electrode layer. An anode electrode layer is connected to a negative electrode lead (not shown), and a cathode electrode layer is connected to a positive electrode lead (not shown). The electrolyte membrane 3 is interposed between the anode 1 and the cathode 2. The anode 1, the cathode 2, and the electrolyte membrane 3 are sintered by a hot pressing method into a single unit as a membrane-electrode assembly (MEA).

An inner surface 1b of the anode 1 is in contact with the electrolyte membrane 3, and an outer surface 1a thereof (the surface of the anode opposite to the electrolyte membrane) is in contact with the porous body 4. The porous body 4 has an inlet port 4D communicating with a fuel tank 8, and has a fuel supplying surface 4A including a porous exposure portion communicating with the anode 1. Channel portions (channel portions) 5 and protruding portions 6 are patterned and formed on the fuel supplying surface 4A of the porous body. The protruding portions 6 protrude from the fuel supplying surface 4A in the X direction, and the top ends of the protruding portions at which a porous material of the protruding portions is exposed to outside, come in contact with the anode surface 1a.

In the porous body 4, the channel portions 5 are formed so as to array a number of the protruding portions 6 in a square lattice pattern, as shown in FIG. 2. As shown in FIG. 3, the bottom surface and the side surfaces of the porous body 4, except the protruding portions 6 and inlet port 4D(see FIG. 1), are covered with a sealing film 7. Other surfaces 4B and 4C of the porous body than the surface 4A are also entirely covered with the sealing film 7. The sealing film 7 is made of a material having a sealing property of blocking the permeation of a fluid.

No sealing film 7 is formed on the top ends of the protruding portions 6, and the material of the porous body 4 is directly exposed to outside at the top end surfaces thereof. The rear surface 4B of the porous body 4 is also covered with the sealing film 7. Three side end surfaces 4C (except one side surface including the inlet port 4D) of the porous body 4 are also covered with the sealing film 7. No sealing film 7 is formed at the inlet port 4D, and the porous material of the porous body 4 is exposed at the inlet. A fuel tank 8 is removably connected to the inlet port 4D of the porous body. A liquid fuel such as an aqueous methanol solution is contained in the fuel tank 8.

The fluid management component 100 is housed in a case (not shown), for example, such that a gas passage 9 defined by the channel portions 5 of the porous body 4 and the anode 1 is opened to the air. One of possible ways to open the gas passage 9 to the air is to form a passage communicating with the gas passage 9 in the case, and to open one end of the passage to the air outside the case.

In FIG. 1, arrowhead broken lines that are directed the porous body 4 to the anode 1 indicate the direction of the flow of the methanol solution, and arrowhead solid lines that are directed from the anode 1 to the channel portions 5 indicate the direction of the flow of gas containing carbon dioxide. Arrowhead solid lines directed toward the cathode 2 indicate the direction of the flow of air (oxygen). Arrowhead broken lines that are directed from the cathode 2 to outside indicate the direction of the flow of water (vapor).

A methanol solution supplied from the fuel tank 8 to the porous body 4 permeates through the porous body 4, oozes out from the top ends of the protruding portions 6, and is supplied to the anode 1. Air containing oxygen is supplied to the cathode 2, and as power generation reaction progresses, carbon dioxide is generated at the anode 1 through the reaction of formula (1). The carbon dioxide flows from the surface of the anode 1, passes through the gas passage 9, and is discharged into the air. The carbon dioxide having flowed into the channel portions 5 is blocked with the sealing film 7, and flows along the channel portions 5 and toward the end of the porous body 4 while not permeating through the porous body 4, and finally is discharged into the air. With such a flow, there is less chance that the fuel evaporates from the surface of the channel portions 5 and the fuel transpires together with the carbon dioxide, and hence, the fuel utilization efficiency is enhanced. As a result, the fuel cell is driven for a longer time by using a smaller fuel tank (fuel cartridge), and hence, the volume energy density of the fuel cell system is increased.

In the porous body, an area ratio of the protruding portions 6 to the fuel supplying surface 4A is selected to be preferably within a range of 25 to 75%. If the area ratio of the protruding portions 6 is smaller than 25%, there is a danger that an insufficient amount of fuel is supplied to the anode. If the area ratio of the protruding portions 6 exceeds 75%, on the other hand, there is a danger that the carbon dioxide could be insufficiently discharged. A more preferable range of the area of the protruding portions 6 where those are in contact with the anode 1 is 33% to 67% of the area of the fuel supplying surface 4A of the porous body. A width P of each protruding portion 6 is determined such that the area ratio of the protruding portions fall within such an adequate range.

A width W of the channel portions 5 shown in FIG. 3 is selected preferably to such an extent that the opening of the channel portions is not closed by a surface tension of the fuel. A depth D of the channel portions 5 may be selected to be within a range of 0.5 to 1.0 mm, for example. Intervals P each between the adjacent channel portions 5, i.e., widths of the protruding portions 6, are preferably equal to one another in order to ensure uniform fuel supply.

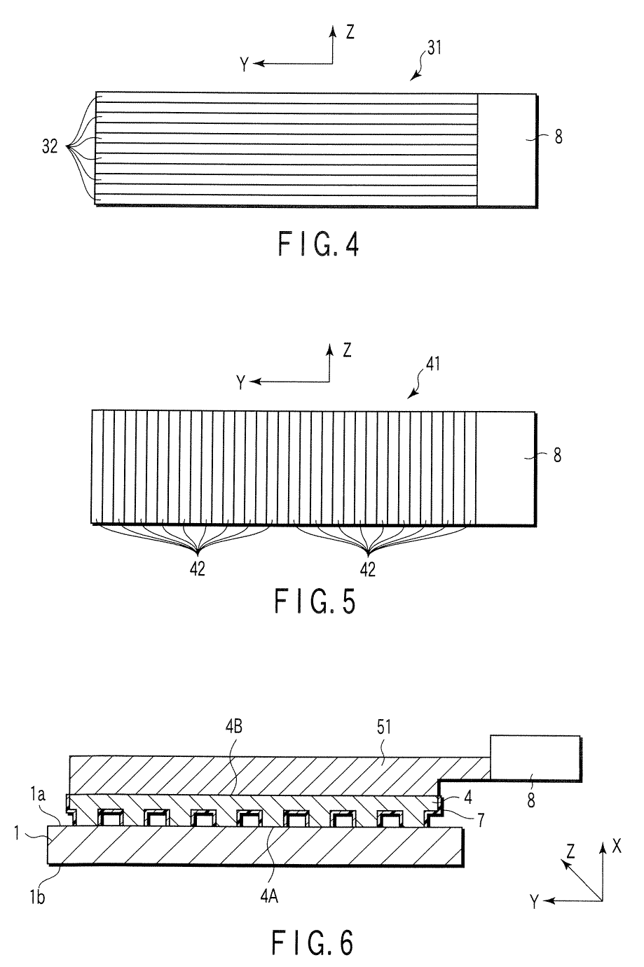

In FIG. 2, the porous body is illustrated which includes the channel portions 5 arranged such that the protruding portions 6 are arrayed in a pattern of a square lattice as viewed in two-dimensional plane. However, the present embodiment is not limited to the example. The pattern may be trapezoidal, diamond, parallelogram, triangle, circular, elliptical, unshaped or the like. The channel portions and the protruding portions may be arranged in stripe patterns on the porous body. Plan views showing porous bodies having stripe patterns of channel portions are shown in FIGS. 4 and 5.

As shown in FIG. 4, channel portions 32 may be arrayed to have a pattern of stripes extending in a longitudinal direction (Y direction) of a porous body 31. As shown in FIG. 5, channel portions 42 may be arrayed to have a pattern of stripes extending in a direction (Z direction) perpendicular to a longitudinal direction of a porous body 41. When the pattern of the channel portions 42 extending perpendicular to the longitudinal direction is used, a distance of the gas passage 9 is reduced to thereby enhance the carbon dioxide discharging efficiency. In addition, the channel portions may be arrayed to have a stripe pattern extending obliquely to the longitudinal direction of the porous body.

[Porous Body]

A porosity of each of the porous bodies 4, 31 and 41 is preferably within a range from 10% to 50%. If the porosity is less than 10%, there is a danger that the permeability of the fuel will deteriorate. If the porosity exceeds 50%, there is in danger of decreasing the electric conductivity of the porous body as well as its strength.

Each of the porous bodies 4, 31 and 41 is preferably porous carbon. The porous carbon is stable, and excellent in electric conductivity, and, its porosity control is easy. The porous carbon may be manufactured by compression molding carbon particles of carbon black, for example. The porous carbon may also be manufactured by kneading and mixing carbon particles and a binder, and sintering the resultant. A porosity of the porous carbon may be controlled by adjusting the particle diameter of carbon particles, compression conditions, the amount of the binder, etc.

[Sealing Film]

The sealing film 7 can block the permeation of a fluid (liquid, gas or air-liquid mixture), and is made of a film material which is hard to peel off and is thermally stable. Since the carbon dioxide is generated at the anode, the atmosphere is acidic and heated to high temperature. For this reason, it is preferable that the sealing film 7 is stable even in a high temperature, acidic atmosphere. The sealing film 7 may be made of, for example, a resin material. The sealing film 7 preferably contains at least one material selected from the group consisting of polytetrafluoroethylene, polyimide resin and epoxy resin. The sealing film 7 containing the polytetrafluoroethylene, polyimide resin or epoxy resin is hard to permeate into the porous body, and is stable even in a high temperature, acidic atmosphere. A modulus of elasticity and a coefficient of thermal expansion of the material are relatively low. Accordingly, the material is hard to peel off. In the present specification, “permeate” means that a fluid moves from one side of a membrane to the other side thereof at normal temperatures and under atmospheric pressure, but does not involve ooze (leakage) of a micro-amount of a fluid at a molecular level.

A thickness of the sealing film 7 is preferably 10 μm or smaller when the main focus is placed on increase of the carbon-dioxide discharging efficiency. This is because as the sealing film 7 is thicker, the carbon-dioxide discharging efficiency can be more increased. On the other hand, when the main focus is placed on the blocking of the fluid permeation, the thickness of the sealing film 7 is preferably 10 μm or thicker. As a consequence, evaporation of the liquid fuel can be further reduced.

By forming the sealing film 7 so as to cover the surfaces defining the channel portions 5 and, if necessary, the rear surface 4B and the side end surface 4C, it is possible to reduce an amount of evaporation of the methanol solution having permeated into the porous body 4. When the fuel cell is not used, it is preferable to close a passage which is formed in the case or the like to open the gas passage 9 to the air, thereby isolating the channel portions 5 from the outside air. By so doing, an amount of evaporation of the methanol solution is further reduced to further increase the fuel utilization efficiency. Moreover, it is preferable that the side end surface 4C (end surface as viewed in the Z direction) of the porous body 4 is also covered with the sealing film 7. With this, the fuel utilization efficiency is further enhanced. When the porous body is housed in a case such that this peripheral side surface is in close contact with, for example, the case wall, there is no need of forming the sealing film 7 thereon.

In FIG. 1, the fuel is directly supplied from the fuel tank 8 to the porous body 4 having the channel portions 5, but the present embodiment is not limited to such a fuel supply. For example, the surface 4B of the porous body 4, which is opposite to the surface thereof facing the anode 1, is not covered with the sealing film 7, and as shown in FIG. 6, another porous body 51 is layered on the surface 4B, and the fuel tank 8 is directly connected to the porous body 51 for fuel supply. No channel portions are required to be formed in this additional porous body 51. The fuel supplied from the fuel tank 8 first permeates through the additional porous body 51 and then the porous body 4 having the channel portions 5, and is supplied to the anode 1 as described above. A porous body having a higher porosity than the porous body 4 is preferably used for the porous body 51. Provision of the porous body 51 enhances the permeability of the fuel diffusing in the longitudinal direction (Y direction) from the fuel tank 8. As a result, the fuel is more uniformly supplied to the anode 1. A thickness of the additional porous body 51 may be within 0.5 to 1.0 mm, for example. The total thickness of the porous body 4 and the porous body 51 may be within 2.5 to 3.0 mm, for example.

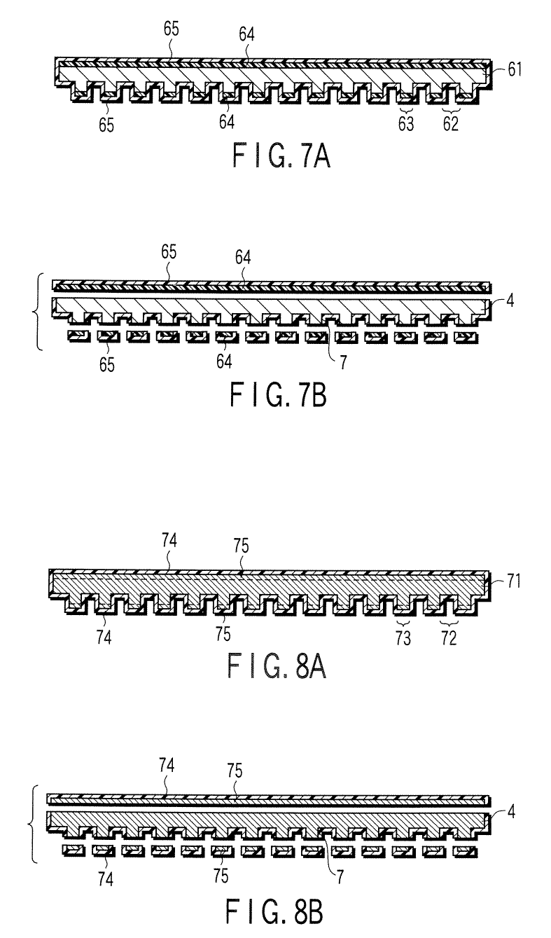

A first method of manufacturing a porous body will be described with reference to FIGS. 7A and 7B.

An irregular pattern is formed on one side of a sheet-like preform to thereby obtain a form 61 having channel portions 62 and protruding portions 63. The form 61 may be formed in a manner that a mold having a pattern of the channel portions 62 and the protruding portions 63 is filled with carbon particles, and the resultant is compression molded or sintered. Alternatively, for example, a mold is filled with carbon particles and the resultant is compression molded or sintered to form a sheet-like preform. Channel portions 62 are formed in one side of the preform by using a cutting tool such as a cutter, a plane or a whetstone, or etching process such as chemical etching process or photo-etching process, to thereby prepare a form 61.

As shown in FIG. 7A, a mask 64 having patterned openings corresponding to the channel portions 62 and the inlet port 4D(see FIG. 1) is attached to the form 61 to cover one side of the form 61. When the porous body having the pattern as shown in FIG. 2 is manufactured, bridges are provided, for example, at the patterned openings of the mask 64, and mask portions corresponding to the protruding portions are supported by the bridges. The bridges are provided for preventing the mask parts from being separated into pieces, and a size and a shape of the bridge are selected so as not to hinder film formation to be described later. When the porous bodies having the patterns shown in FIGS. 4 and 5 are manufactured, the channel portions 62 and the mask 64 may be concurrently formed. More specifically, a blind mask (having no patterned openings) is stuck onto one side of a sheet-like preform. This side is grooved by using a cutting tool to obtain a form 61 in which the mask 64 is attached to the protruding portions 63.

To manufacture a fluid management component of the type shown in FIG. 1, a blind mask 64 is attached also to one side end surface 4D of the form 61 in order to form a fuel inlet. To manufacture a component of the type shown in FIG. 6, the blind mask 64 is attached also to the rear surface 4B of the form 61 in order to form a fuel inlet.

Then, a sealing film 7 is formed on the channel portions 62 of the form 61 by film forming means. To be more specific, the whole form 61 having the mask 64 attached therewith is immersed in a solution containing a precursor of the sealing film, or the entire surface including the inner surfaces of the channel portions 62 of the form 61 is coated with the solution or the solution is vapor-deposited on the entire surface, and then the resultant is dried thereby to form a sealing film. A screen printing process or a CVD process may be used for the film forming means.

When, after the film forming, the mask 64 is removed as shown in FIG. 7B, an unnecessary sealing film 65 is removed together with the mask 64, and a desired porous body 4 is produced.

A second method of manufacturing a porous body will be described with reference to FIGS. 8A and 8B.

A pattern of channel portions 72 and protruding portions 73 is formed on one side of a sheet-like preform to thereby form a form 71, in the same manner as in the first manufacturing method. As shown in FIG. 8A, a sealing film is formed on the whole of the form 71, as described above. Thereafter, as shown in FIG. 8B, an unnecessary sealing film 74, which is formed the top end surfaces, the end surfaces orthogonal to the longitudinal direction and/or the surfaces opposite to the surface having channel portions formed therein, is selectively removed by physical removing means or chemical removing means. The physical removing means may be a cutting tool, such as a cutter, a plane, or a whetstone. The chemical removing means may be etching process. The etching process may be chemical etching, gas etching, plasma etching or the like. As a result, an intended porous body 4 is produced.

In the second manufacturing method, it is preferable that a cutting margin 75 is previously formed on the preform. A thickness of the cutting margin 75 may be within a range from 10 to 20 μm, for example. A porous body 4 having more flatter protruding portions can be obtained in a simple manner by removing the cutting margin 75 and the unnecessary sealing film 74.

Now, the anode, the cathode and the electrolyte membrane, which are used for the fluid management component of the embodiment, will be described.

The anode 1 and the cathode 2 each have a structure in which a catalyst layer is layered on a diffusion layer (current collector). The anode 1 and the cathode 2 are arranged such that the catalyst layers are confronted with the electrolyte membrane. A porous carbon sheet, for example, may be used for the diffusion layer. The porous body having unevenness is layered on the anode diffusion layer. The anode diffusion layer may be omitted. In this case, the porous body having unevenness is directly layered on the anode catalyst layer.

The catalyst layer of each of the anode 1 and the cathode 2 contains a supported catalyst supporting a catalyst metal such as Rt or Ru, a proton conductive material, and if necessary, a conductive material. Carbon black may be enumerated for the support of the supported catalyst and the conductive material.

The electrolyte membrane 3 contains a proton conductive material. The proton conductive material contained in the anode catalyst layer, the cathode catalyst layer and the electrolyte layer may be any material as long as it allows protons to travel therethrough. Examples of the proton conductive materials include a fluorine plastic having a sulfonic acid group, such as Nafion (trademark of Du Pont K.K.), Flemion (trademark of Asahi Glass Company) and Aciplex (trademark of Asahi Chemical Industry Co., Ltd.), and an inorganic material such as tungstic acid or phosphotungstic acid, but not limited thereto.

### EXAMPLE

As shown in FIG. 2, channel portions were formed in a sheet-like porous carbon 2 mm thick such that protruding portions were arrayed in a square lattice pattern. A width W and a depth D of the recessed portion were 1 mm and 1 mm, respectively. A width (P) of the protruding portion was 1.4 mm, and the top end surface of the protruding portion was square in shape. In other words, an area ratio of the protruding portions of the porous carbon to the surface of the porous carbon having unevenness, was 50%. As described referring to FIGS. 7A and 7B, a polyimide resin as the sealing film 65 was formed on the porous carbon. The polyimide resin film was formed entirely on the surface of the porous carbon except the protruding portions and one end of the porous body to which the fuel cartridge is connected. A film thickness of the polyimide resin film was 50 μm. A fuel cell having the structure shown in FIG. 1 was manufactured by using the porous body thus formed, and was driven to generate electric power at an operation temperature of 50° C. The result was that the fuel evaporation was reduced by a maximum of 10% compared to that in the case having no sealing film.

Substantially the same useful results were produced in the cases using the polytetrafluoroethylene film and the epoxy resin film, and the case where the sealing film 74 was formed as described with reference to FIGS. 8A and 8B. It was confirmed that the fuel utilizing efficiency was increased.

Thus, the fuel cell of the present invention can achieve an excellent fuel utilization efficiency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fluid management component for use in a fuel cell, comprising:
an anode;
a cathode;
an electrolyte membrane provided between the anode and the cathode;
a porous body having a fuel supplying surface portion which faces a surface of the anode opposite to the electrolyte membrane and has channel portions and protruding portions in contact with the anode; and
a sealing film which covers at least parts of the channel portions and blocks the permeation of a fluid through the fuel supplying surface portion.

2. The fluid management component according to claim 1, wherein the sealing film contains at least one material selected from the group consisting of polytetrafluoroethylene, polyimide resin and epoxy resin.

3. The fluid management component according to claim 1, wherein the porous body is a porous body obtained by compression molding carbon particles or by kneading and mixing carbon particles together with a binder, and sintering the resultant.

4. The fluid management component according to claim 1, wherein the porous body is formed by forming a pattern of channel portions and protruding portions on one side of a sheet-like preform; attaching a mask having patterned openings corresponding to the channel portions to the preform to cover one side of the preform; and forming the sealing film on the channel portions of the preform through the mask.

5. The fluid management component according to claim 1, wherein the porous body is formed by forming a pattern of channel portions and protruding portions on one side of a sheet-like preform; forming the sealing film on the entire surface of one side of the preform; and selectively removing the sealing film which covers the protruding portions by using physical removing means or chemical removing means.

6. The fluid management component according to claim 1, wherein the porous body has a fuel inlet port not covered with the sealing film.

7. The fluid management component according to claim 6, wherein another porous body is located between the fuel inlet port of the porous body and a fuel tank.

8. The fluid management component according to claim 1, wherein a porosity of the porous body is 10% or more and 50% or less.

9. A method of manufacturing a fluid management component for use in a fuel cell, comprising:
(a) forming a pattern of channel portions and protruding portions on one side of a sheet-like preform;
(b) attaching a mask having patterned openings corresponding to the channel portions of the preform to the preform, and covering one side of the preform with the mask;
(c) forming a sealing film on the channel portions of the preform through the mask, and then removing an unnecessary film as well as the mask, thereby forming a porous body having a fuel inlet port and a fuel supplying surface portion;
(d) sintering an anode, a cathode and an electrolyte membrane by a hot pressing method into a unit body, thereby obtaining a membrane electrode assembly; and
(e) mounting the porous body on the membrane electrode assembly so that the protruding portions of the fuel supplying surface portion are in contact with the anode, and mounting the porous body on a fuel tank so that the fuel inlet port communicates with the fuel tank.

10. A method of manufacturing a fluid management component for use in a fuel cell, comprising:
(i) forming a pattern of channel portions and protruding portions on one side of a sheet-like preform;
(ii) forming a sealing film on the entire surface of the one side of the preform;
(iii) selectively removing the sealing film from the protruding portions by using physical removing means or chemical removing means, thereby obtaining a porous body having a fuel inlet port and a fuel tank;
(iv) sintering an anode, a cathode and an electrolyte membrane by a hot pressing method into a unit body, thereby obtaining a membrane electrode assembly; and
(v) mounting the porous body on the membrane electrode assembly so that the protruding portions of the fuel supplying surface portion are in contact with the anode, and mounting the porous body on the fuel tank so that the fuel inlet port communicates with the fuel tank.

11. The method according to claim 10, wherein a cutting margin is previously provided on the preform, and in the step (iii), the cutting margin is removed together with the sealing film.
